(19) United States
(12) Patent Application Publication
(10) Pub. No.: US 2025/0354480 A1
(43) Pub. Date: Nov. 20, 2025

(54) CASING THICKNESS DETERMINATION FROM PULSE-ECHO ULTRASONIC MEASUREMENTS

(71) Applicant: Baker Hughes Oilfield Operations LLC, Houston, TX (US)

(72) Inventor: Pawel Matuszyk, Houston, TX (US)

(73) Assignee: Baker Hughes Oilfield Operations LLC, Houston, TX (US)

(21) Appl. No.: 18/669,101

(22) Filed: May 20, 2024

(51) Int. Cl. E21B 47/085

(52) U.S. Cl. CPC E21B 47/085

(57) ABSTRACT

A casing thickness determination based on complex group delay (CGD) properties calculated for the part of the reflected signal from pulse-echo ultrasonic measurements from a downhole tool. A processing window is selected that includes the first reflection followed by reverberations but excludes other reflections to provide the most accurate casing thickness determination. The real and imaginary parts of the CGD, the deflection point and local extremum respectively, indicate the resonant frequency present in the windowed signal. The casing thickness is then determined from the resonant frequency.

### BACKGROUND

### Field of the Disclosure

The present disclosure generally relates to wellbore logging. More specifically, embodiments of the disclosure relate to determining the thickness of casing installed in a wellbore using pulse-echo ultrasonic measurements.

### Description of the Related Art

Wellbore (also referred to as “well”) logging systems are typically used in hydrocarbon exploration. Such systems provide data for use by geologists and petroleum engineers in making determinations relating to the extraction and production of hydrocarbons from hydrocarbon-bearing reservoirs. These systems may include different types of tools and instruments that are disposed in a wellbore to perform various tasks and measurements. Such tools and instruments may include resistivity, gamma density, neutron porosity, sonic, acoustic logging, and pulsed neutron tools. A type of acoustic logging tool measurement, ultrasonic pulse-echo, may be used to characterize material attached to the back of borehole casing.

### SUMMARY

An acoustic logging tool capable of obtaining pulse-echo measurements may include an ultrasonic transducer located inside the borehole and perpendicularly orientated to the casing. The ultrasonic transducer may excite an acoustic pulse that travels through a borehole fluid (for example, a drilling mud) until it impacts the casing and is partially reflected back towards the transducer. The transducer records the acoustic pulse and converts it into an electric signal.

In the presence of a load attached to the casing, a portion of the incident energy signal is transmitted via the casing into the surrounding medium and further dissipated. As a result of the relatively high contrast in mechanical properties of borehole fluid and a steel casing, a significant part of the incident energy is reflected back toward the transducer. Additionally, multiple reflections from both walls inside the casing create a characteristic “tail” in the waveform following the reflected source pulse, referred to as “reverberations.” Because the ultrasonic transducer is made of a material that has significantly different properties than a typical borehole fluid (for example, drilling mud), the signal incoming to the transducer is efficiently reflected back toward the casing, causing a series of reflections. FIG. 1 depicts an example of a pulse-wave echo waveform 100 illustrating this series of reflections. FIG. 1 is a graph of amplitude (on the y-axis) vs. time (on the x-axis) that shows three reflections arriving at t₁ₛₜ, t_{2nd}, and t_{3rd}. The partial waveform plot between times i₀ and i₂ may be used in impedance inversion processing. The partial waveform plot between times i₀ and i may be used in the deconvolution of the source pulse. The identifier tₑ in FIG. 1 indicates the arrival time of the maximum energy of the first reflection.

Embodiments of the disclosure may determine casing thickness by processing the portion of the recorded waveform that overlaps with the first reflection, as this portion depends solely on the mechanical properties of the mud, casing, and load but is not affected by the properties of the transducer in the downhole tool. The inversion process described in the disclosure thus uses the windowed portion of the recorded waveform identified by i₀ and i₂ in FIG. 1.

The reflection of an ultrasonic beam from a steel plate or cylinder may be characterized as a two-dimensional (2D) problem that involves various acoustic phenomena, including the creation of guided waves in a casing, conversion of modes at inter-material interfaces, etc. An indicator of the complexity of a pulse-echo measurement with a perpendicularly oriented transducer typically found in a downhole tool is that the measured thickness resonance frequency fᵣ of a plate/cylinder of thickness h is not directly related to the compressional velocity in steel c₂, such as shown in Equation 1:

$${f}_{r} = \frac{{c}_{2}}{2 h} \qquad ( 1 )$$

Instead, the relationship of plate/cylinder of thickness h to the compressional velocity in steel c₂ is related to the zero-group-velocity (S1-ZGV) of the Lamb S1 guided mode, as shown in Equation 2:

$${f}_{r} = \frac{β {c}_{2}}{2 h} \qquad ( 2 )$$

Where β∈(0,1] is the correction factor related to the Poisson ratio of the casing material. However, the application of a one-dimensional (1D) model in the determination of casing thickness is still desirable and practical due to the significantly lower computational complexity. However, the 2D and three-dimensional (3D) nature of the problem presents various challenges. Embodiments of the disclosure account for the 2D/3D nature of the problem and the curved geometry of the casing.

Disclosed herein is a method of determining a thickness of a casing installed in a wellbore. The method includes obtaining a signal measured by a downhole tool inserted in wellbore of a well, the acoustic signal generated by an acoustic pulse emitted by the downhole tool such that the acoustic pulse contacts the casing, and determining a processing window in the signal by windowing the signal to a first reflection and reverberations of the first reflection. The method further includes determining a complex group delay (CGD) in the processing window, the complex group delay having a real component and an imaginary component, identifying a resonant frequency from the complex group delay, and determining the casing thickness using the resonant frequency. Identifying a resonant frequency from the complex group delay may include identifying the resonant frequency from a minimum of the imaginary component of the complex group delay (CGD). Identifying a resonant frequency from the complex group delay may include identifying the resonant frequency from a deflection point of the real component of the complex group delay (CGD). Determining the casing thickness using the resonant frequency may include determining the casing thickness h using the following:

$${f}_{r} = \frac{β {c}_{2}}{2 h}$$

where fᵣ is the resonant frequency, β is a correction factor related to the Poisson ratio of the casing material, c₂ is the compressional velocity in steel, and h is the casing thickness. Determining the processing window in the signal by windowing the signal to a first reflection and reverberations of the first reflection may include determining the first reflection and associated noise, determining an arrival time and second reflections, and defining the processing window based on a proximity of a minimum of the imaginary component of the complex group delay (CGD) and a deflection point of the real component of the complex group delay (CGD). The downhole tool may include an ultrasonic transducer oriented perpendicularly to the casing. The complex group delay (CGD) Z_{G}(ω) is determined according to the following:

$${Z}_{G} ( ω ) = - \frac{i}{{f}_{r}} \frac{( 1 - {R}_{1}^{2} ) {R}_{2} Q ( ω )}{[ 1 + {R}_{1} {R}_{2} Q ( ω ) ] [ {R}_{1} + {R}_{2} Q ( ω ) ]}$$

where fᵣ is the resonant frequency, R1 is a first reflection coefficient, R2 is a second reflection coefficient, and Q(ω) is an auxiliary quantity.

Also disclosed is a non-transitory computer-readable storage medium having executable code stored thereon for determining a thickness of a casing installed in a wellbore. The executable code has a set of instructions that causes a processor to perform operations that include obtaining a signal measured by a downhole tool inserted in wellbore of a well, the acoustic signal generated by an acoustic pulse emitted by the downhole tool such that the acoustic pulse contacts the casing, and determining a processing window in the signal by windowing the signal to a first reflection and reverberations of the first reflection. The operations further include determining a complex group delay (CGD) in the processing window, the complex group delay having a real component and an imaginary component, identifying a resonant frequency from the complex group delay, and determining the casing thickness using the resonant frequency. Identifying a resonant frequency from the complex group delay may include identifying the resonant frequency from a minimum of the imaginary component of the complex group delay (CGD). Identifying a resonant frequency from the complex group delay may include identifying the resonant frequency from a deflection point of the real component of the complex group delay (CGD). Determining the casing thickness using the resonant frequency may include determining the casing thickness h using the following:

$${f}_{r} = \frac{β {c}_{2}}{2 h}$$

where fᵣ is the resonant frequency, β is a correction factor related to the Poisson ratio of the casing material, c₂ is the compressional velocity in steel, and h is the casing thickness. Determining the processing window in the signal by windowing the signal to a first reflection and reverberations of the first reflection may include determining the first reflection and associated noise, determining an arrival time and second reflections, and defining the processing window based on a proximity of a minimum of the imaginary component of the complex group delay (CGD) and a deflection point of the real component of the complex group delay (CGD). The downhole tool may include an ultrasonic transducer oriented perpendicularly to the casing. The complex group delay (CGD) Z_{G}(ω) is determined according to the following:

$${Z}_{G} ( ω ) = - \frac{i}{{f}_{r}} \frac{( 1 - {R}_{1}^{2} ) {R}_{2} Q ( ω )}{[ 1 + {R}_{1} {R}_{2} Q ( ω ) ] [ {R}_{1} + {R}_{2} Q ( ω ) ]}$$

where fᵣ is the resonant frequency, R1 is a first reflection coefficient, R2 is a second reflection coefficient, and Q(ω) is an auxiliary quantity.

Also disclosed is a system for determining the thickness of a casing installed in a wellbore. The system includes a downhole tool, an ultrasonic transducer oriented perpendicular to the casing, and a controller communicatively coupled to the downhole tool, the controller includes a non-transitory computer-readable memory having executable code stored thereon. The executable code has a set of instructions that causes a processor to perform operations that include obtaining a signal measured by the downhole tool, the acoustic signal generated by an acoustic pulse emitted by the downhole tool such that the acoustic pulse contacts the casing, and determining a processing window in the signal by windowing the signal to a first reflection and reverberations of the first reflection. The operations further include determining a complex group delay (CGD) in the processing window, the complex group delay having a real component and an imaginary component, identifying a resonant frequency from the complex group delay, and determining the casing thickness using the resonant frequency. Identifying a resonant frequency from the complex group delay may include identifying the resonant frequency from a minimum of the imaginary component of the complex group delay (CGD). Identifying a resonant frequency from the complex group delay may include identifying the resonant frequency from a deflection point of the real component of the complex group delay (CGD). Determining the casing thickness using the resonant frequency may include determining the casing thickness h using the following:

$${f}_{r} = \frac{β {c}_{2}}{2 h}$$

where fᵣ is the resonant frequency, β is a correction factor related to the Poisson ratio of the casing material, c₂ is the compressional velocity in steel, and h is the casing thickness. Determining the processing window in the signal by windowing the signal to a first reflection and reverberations of the first reflection may include determining the first reflection and associated noise, determining an arrival time and second reflections, and defining the processing window based on a proximity of a minimum of the imaginary component of the complex group delay (CGD) and a deflection point of the real component of the complex group delay (CGD). The complex group delay (CGD) Z_{G}(ω) is determined according to the following:

$${Z}_{G} ( ω ) = - \frac{i}{{f}_{r}} \frac{( 1 - {R}_{1}^{2} ) {R}_{2} Q ( ω )}{[ 1 + {R}_{1} {R}_{2} Q ( ω ) ] [ {R}_{1} + {R}_{2} Q ( ω ) ]}$$

where fᵣ is the resonant frequency, R1 is a first reflection coefficient, R2 is a second reflection coefficient, and Q(ω) is an auxiliary quantity.

### BRIEF DESCRIPTION OF THE DRAWINGS

FIG. 1 depicts an example of a pulse-wave echo waveform illustrating a series of reflections in accordance with an embodiment of the disclosure;

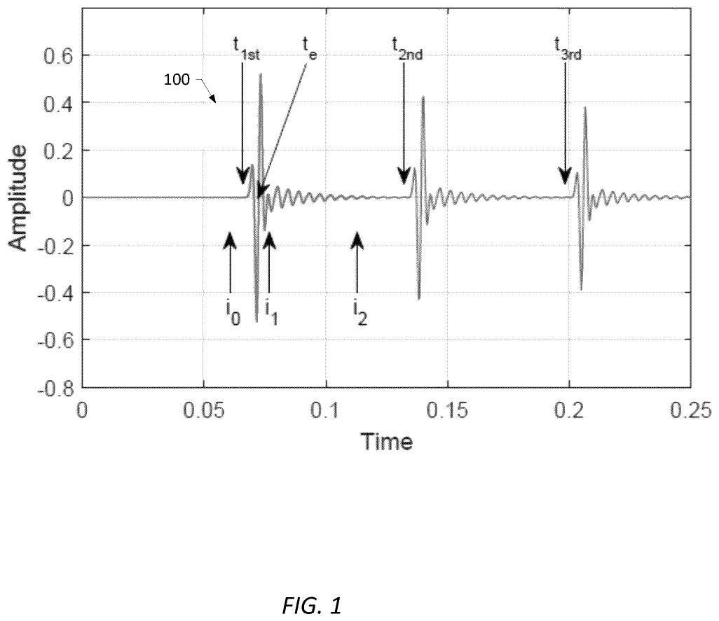

FIG. 2 is schematic diagram of a side-sectional view of a well environment in accordance with an embodiment of the disclosure;

FIG. 3 is a flowchart of a process for determining casing thickness in accordance with an embodiment of the disclosure;

FIGS. 4A-4C depict plots of a waveform, S(t) function, and an Ê(t) function in accordance with an embodiment of the disclosure;

FIGS. 5A-5D depicts plots of waveforms and corresponding instantaneous energy Ê(t) in accordance with an embodiment of the disclosure;

FIGS. 6A and 6B depict an example sweep through a range of processing windows for the waveform depicted in FIG. 4 and in accordance with an embodiment of the present disclosure;

FIGS. 7A and 7B depict an example sweep through a range of processing windows for the waveform depicted in FIG. 5 and in accordance with an embodiment of the present disclosure;

FIG. 8 depicts a one-dimensional (1D) model of the reflection from a loaded casing in accordance with an embodiment of the disclosure; and

FIGS. 9A and 9B depict plots of complex group delay (CGD) in accordance with an embodiment of the disclosure.

### DETAILED DESCRIPTION

The present disclosure will be described more fully with reference to the accompanying drawings, which illustrate embodiments of the disclosure. This disclosure may, however, be embodied in many different forms and should not be construed as limited to the illustrated embodiments. Rather, these embodiments are provided so that this disclosure will be thorough and complete, and will fully convey the scope of the disclosure to those skilled in the art.

Embodiments of the disclosure are directed to casing thickness determination based on complex group delay (CGD) properties calculated for the part of the reflected signal. As discussed herein, the mathematical features of the real and imaginary part of the CGD, the deflection point and local extremum, respectively, indicate the resonant frequency present in the processed signal and, thus, enable the determining of the casing thickness. Embodiments of the disclosure include the selection of the processing window that provides the most accurate casing thickness determination. As described herein, the processing window includes the first reflection followed by reverberations but excludes other reflections (consecutive reflections in the casing as well as the undesired reflections from other surfaces) and noise.

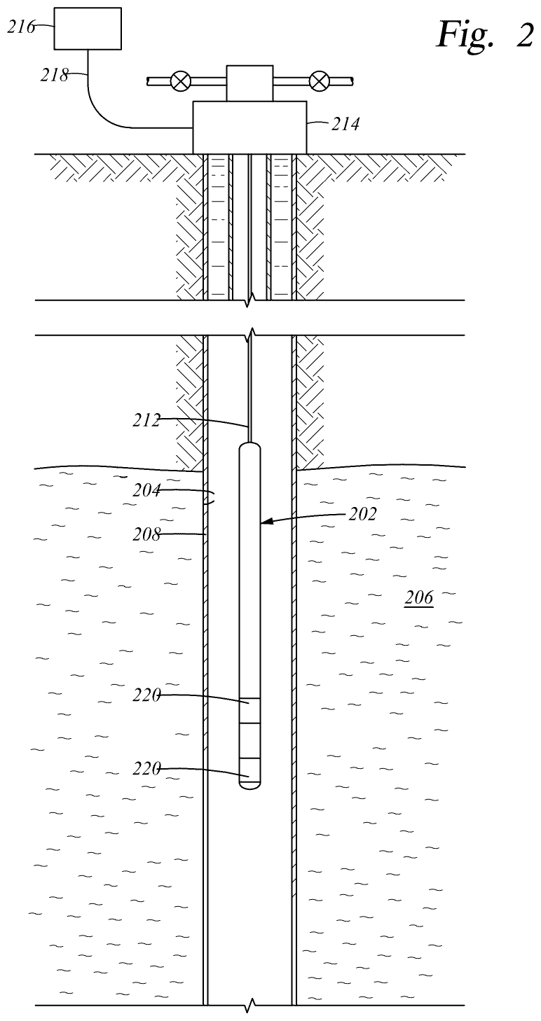

FIG. 2 depicts a well environment 200 in a side sectional view in accordance with an embodiment of the disclosure. The well environment 200 includes an example of a downhole tool 202 that is disposed in a wellbore 204 that intersects a subterranean formation 206. In the example, a string of casing 208 lines wellbore 204, which can be cemented in place in wellbore 204.

Downhole tool 202 is disposed within wellbore 204 on a wireline 212 shown extending up to the opening of wellbore 204 and being threaded through a wellhead assembly 214. Optionally, coiled tubing, slick line, cable, or other means may be used for deploying downhole tool 202 within wellbore 204. A controller 216 is shown on the surface for communicating with the downhole tool 202. A communication means 218 communicatively couples controller 216 with wellhead assembly 214 and is shown as a hardwired assembly. In other embodiments, the communication means 218 may be wireless, fiber optic, or other means of relaying signals or data communication. In some embodiments, the downhole tool 202 may be operated from a service truck having a spool for the wireline 212 and other components.

In the example of FIG. 2, downhole tool 202 is a logging or measurement tool, such as an acoustic logging tool that may include a series of modules coupled together. In such embodiments, the downhole tool 202 may include one or more transducers 220 (that is, an arrangement of transducers such as an array) that both generate and receive acoustic signals. In some embodiments, the downhole tool 202 may include other components, such as dampeners. In some embodiments, the downhole tool 202 may additionally or alternatively include transmitters and receivers, such that the transmitter generates acoustic signals that are then received by the receivers.

The transducers 220 may be used to emit acoustic signals that are detected by the transducers after interaction with objects in the wellbore 204. For example, in the embodiment described herein, the transducers 220 may emit acoustic signals that are reflected by the casing 208 and may be used to determine the characteristics of the casing after detection by the transducers 220. The downhole tool 202 may operate using one or more acoustic measurement techniques suitable for measuring characteristics of the casing, such as pulse-echo (time-of-flight), plane compressional half-wave resonance, and constant (non-dispersive) wave velocity.

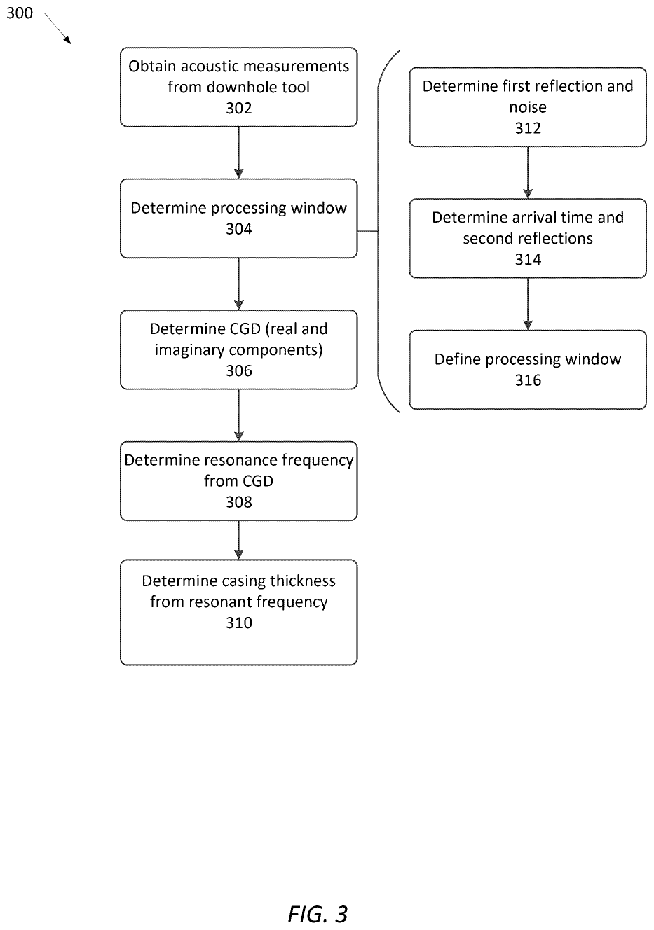

FIG. 3 depicts a process 300 for determining casing thickness in accordance with an embodiment of the disclosure. The process 300 for determining casing thickness may be performed in combination with other operations using a downhole tool. As shown in FIG. 3, process 300 includes obtaining acoustic signal measurements from a downhole tool (block 302), determining a processing window (block 304), determining real and imaginary components of the complex group delay (CDG) (block 306), determining a resonance frequency (block 308), and determining a casing thickness (block 310). Each element of the process 300 is discussed in detail infra.

Initially, acoustic signal measurements may be obtained using a downhole tool (block 302). For example, as discussed supra, the downhole tool 202 may be lowered into a wellbore of a well (for example, a development well or production well) accessing a formation via a wireline or other mechanism. The downhole tool 202 may be oriented perpendicularly to the casing 108 and may be operated in an ultrasonic pulse-echo mode. An acoustic pulse may be generated from one or more transducers 220 and travel through a drilling fluid (also referred to as a “drilling mud”), impact the casing, and partially reflect back towards the one or more transducers 220. The one or more transducers 220 record the reflected acoustic pulse and convert it to an electric signal used in the process 300.

Next, the processing window may be determined (block 304). As discussed infra, the derivations for CGD assume that CGD is calculated from the entire acoustic signal y(t). Determination of the processing window thus includes eliminating undesirable transducer interference (the 2nd and consecutive reflections) by restricting the signal to the first reflection and its reverberations. As discussed herein, the CGD determination is then performed on the resulting partial waveform within the processing window.

As shown in FIG. 3, the determination of the processing window (block 304) includes determining the first reflection and noise (block 312), determining the arrival time and second reflections (block 314), and then defining the processing window (block 316).

Determining the first reflection and noise (block 312) first includes isolating the first reflection portion of the signal, as this is the strongest part of the signal, even in view of moderate noise. Initially, the time integral of the energy of the signal is approximated by squaring the sampled waveform amplitudes wᵢ (i=1, . . . ,N) and calculating the cumulative sum as follows:

$${S}_{i} = {\sum }_{j = 1}^{i} {w}_{j}^{2} \approx S ( t ) = {\int }_{{t}_{1}}^{t} E ( τ ) d ( τ ) \qquad ( 3 )$$

Next, the smoothed first derivative of this cumulative sum is calculated by convolving Sᵢ with an appropriate Savitzky-Golay filter, which approximates the smoothed instantaneous energy (Ê) of the signal, as follows:

$${\hat{E}}_{i} = {\sum }_{j = - m}^{m} {h}_{j} {S}_{i - j} \approx \hat{E} ( {t}_{i} ) \qquad ( 4 )$$

where the size of the filter is equal to 2m+1.

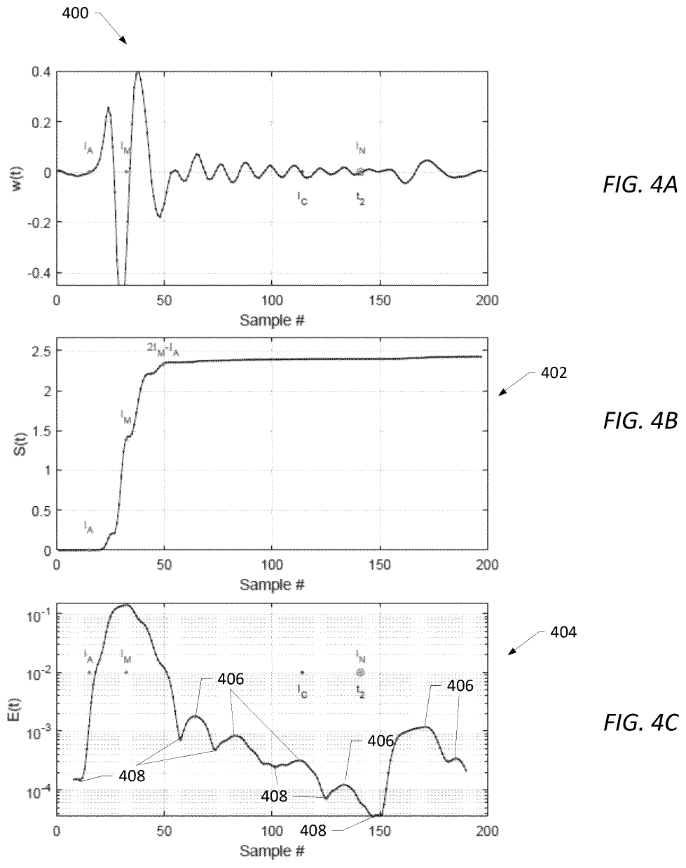

The calculations described above ensure that the calculated values of Êᵢ are all non-negative. FIGS. 4A-4C depict these calculations described above as applied to a waveform in accordance with an embodiment of the disclosure. FIG. 4A is plot 400 of a waveform w(t) vs sample number without significant noise, FIG. 4B is a plot 402 of an S(t) function vs sample number calculated according to Equation 3, and FIG. 4C is a plot of 404 of an Ê(t) function vs sample number calculated according to Equation 4. Each plot 400, 402, and 404 includes markers for determined arrival time (I_{A}), maximum instantaneous energy (I_{M}), and beginning of end noise (I_{N}). FIGS. 4A and 4C also depict the arrival time of the second reflection (t₂) and the end of the window containing the required number of resonance cycles (I_{C}) calculated using nominal casing thickness. Plot 404 also indicates the determined maximum 406 and determined minima 408 of Ê(t).

As shown in FIGS. 4A-4C, the most significant increase in S(t) occurs around the arrival of the most energetic direct first reflection pulse. This characteristic may be used to detect and quantify the front-noise in the acquired waveform. Additionally, smoothed instantaneous energy, (t), exhibits a sequence of decaying minima and maxima after the initial first reflection pulse until the direct second reflection arrives. The deviations from this trend may be used to determine the presence of undesirable end-noise, providing for accurate truncating of the reverberation part of the first reflection signal.

Embodiments of the disclosure further include the following techniques to extend the determinations described supra. First, the maxima and minima of Ê(t) may be determined by finding integer sample numbers corresponding to these peaks and then using quadratic interpolation between samples to obtain more precise values (xⱼ, yⱼ), such that xⱼ are real-valued locations of the peaks, and yⱼ are the corresponding peaks' values of Êᵢ. The locations xⱼ may be treated as the extension of the “sample number” concept to the real values. The peaks may be ordered from left to right, such as xⱼ<xⱼ+1 for each j.

Additionally, the pairs of neighboring peaks (positive and negative, regardless of the order) may be eliminated if they are located too close, as determined by the following:

$${x}_{j + 1} - {x}_{j} < {P}_{thr} \qquad ( 5 )$$

where Pₜₕᵣ is the preselected value of the threshold in terms of samples (for example, Pₜₕᵣ=2.5 samples). This step allows for eliminating peaks, which are artifacts of the determination of Êᵢ, as the combination of the Savitzky-Golay filter size, sampling frequency, and the frequency content of the sampled signal affects the variability and resolution of the calculated instantaneous energy.

The location, I_{M}, and the value of the maximum of the instantaneous energy, E_{M}, may be determined according to the following:

$$k = arg {max}_{j} {y}_{j} , {I}_{M} = {x}_{k} , {E}_{M} = {y}_{k} \qquad ( 6 )$$

The location I_{M} (and its integer rounding) may be the primary reference point for the processing window. The time corresponding to the maximum energy may be denoted by t_{M}.

The arrival index (real-valued), I_{A}, corresponding to the arrival time (t_{A}) of the reflected signal may also be determined. This location may be used as the beginning of the CGD processing widow. The I_{A} may be determined by moving from sample [I_{M}] toward the beginning of the waveform until the following condition is reached:

$${y}_{k} < {E}_{m} \cdot {A}_{thr} \qquad ( 7 )$$

where Aₜₕᵣ is the preselected value of the amplitude threshold (for example, Aₜₕᵣ=0.01). The linear interpolation may be used to refine the value of I_{A} around integer k. At this stage, if a sample with the amplitude satisfying the above condition is not found, an appropriate error flag may be set to indicate the presence of the front-noise in the processed waveform.

An additional check for the presence of the front-noise may be performed by analyzing the ratio of cumulative energies around [symbol] , according to the following:

$$β = \frac{{\int }_{{t}_{M - δ}}^{{t}_{M + δ}} E ( τ ) d ( τ )}{{\int }_{{t}_{1}}^{{t}_{M + 3 δ}} E ( τ ) d ( τ )} = \frac{{s}_{〈 2 {I}_{M} - {I}_{A} 〉} - {s}_{〈 {I}_{A} 〉}}{{s}_{〈 4 {I}_{M} - 3 {I}_{A} 〉}} , δ = {t}_{M} - {t}_{A} \qquad ( 8 )$$

where [symbol] denotes the operation of rounding to the nearest integer and parameter β expresses the ratio of the cumulative energy of the initial pulse of width 2δ after the arrival time to the entire cumulative energy of the waveform. To eliminate the problem of possible additional noise after time t_{M}, as well as the consecutive reflections, the waveform limited to time t_{M}+3δ. The significant front-noise in the processed waveform is present under the following conditions:

$$β < {F}_{thr} \qquad ( 9 )$$

where Fₜₕᵣ<1 is the preselected value of the front-noise threshold (for example, Fₜₕᵣ=0.85).

Additionally, the end-noise may be determined. The primary source of the undesired end-noise is the additional reflections coming from the casing or any other source. As will be appreciated, the direct reflection pulse is followed by decaying reverberations. Thus, the corresponding energy peaks (maxima in Êᵢ) should monotonously decrease. However, one exception may be the first energy maximum after the first (energy dominant) peak, which—depending on the interference pattern—may be lower than the consecutive energy maximum. Consequently, in a clean and undisturbed recorded signal, all positive (as well as negative) energy peaks may (exponentially) decay until the arrival of the second reflection, which carries larger energy coming from the direct reflection from the casing surface. Any noise and undesired reflections arriving before the second reflection from the casing bring additional energy to this part of the signal and disturb the decaying trend of the energy peaks. As a result, inspecting the decay trend of positive and negative energy peaks enables the detection of a significant noise present in the final part of the waveform under interest.

The trend inspection may begin from the second positive peak after the maximal peak (i.e., yⱼ where j=k+4 and k=argmaxⱼ yⱼ). It continues for consecutive peaks until the following condition is satisfied:

$${y}_{j} \leq α {y}_{j - 2} \qquad ( 10 )$$

where α is the relaxation parameter close to 1 (for example, α=1.01). Having the first peak index j for which the above relation is not satisfied, the end-noise index may be set according to the following:

$${I}_{N} = \{ \begin{matrix}j - 1 & if {y}_{j} is a local maximum , or \\ j - 2 & if {y}_{j} is a local minimum\end{matrix} \qquad ( 11 )$$

Otherwise, if the trend is monotonic, I_{N}=N (the end of the waveform).

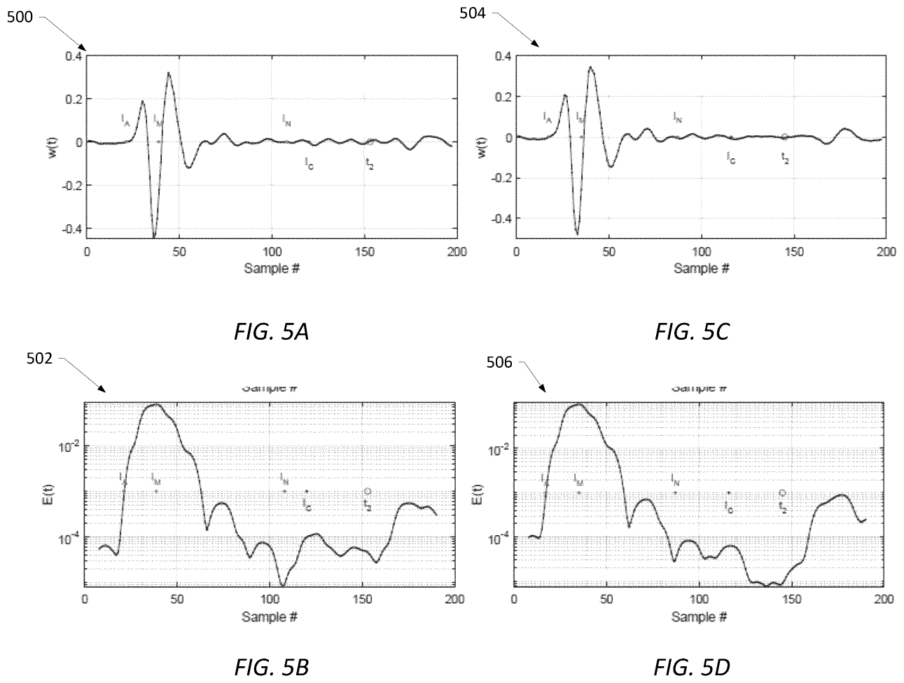

FIGS. 5A-5D depict examples of the application of this criterion for noise waveforms in accordance with an embodiment of the disclosure. FIG. 5A depicts an example plot 500 of waveform w(t) vs sample number, and FIG. 5B. depicts a respective plot 502 of instantaneous energy Ê(t) for the waveform of FIG. 5A. Similarly, FIG. 5C depicts an example plot 504 of waveform w(t) vs sample number, and FIG. 5D. depicts a respective plot 506 of instantaneous energy Ê(t) for the waveform of FIG. 5C. Each plot 500, 502, 504, and 506 depicts I_{A}, I_{M}, I_{N}, I_{C}, and tz as discussed supra. In both examples depicted in FIGS. 5A-5D, the presence of the end-noise in the reverberation part of the signal (as indicated by I_{N}) truncates the waveform earlier than just using a nominal number of cycles (indicated by I_{C})

Next, as shown in FIG. 3, the arrival time and second reflections are determined (block 314). With the known time t₀ at which waveforms are recorded (after firing a source pulse at time t=0), the arrival time of the first reflection pulse may be determined as follows:

$${t}_{1} = {t}_{0} + ( {I}_{A} - 1 ) \cdot Δ t \qquad ( 12 )$$

where Δt is the sampling time of the waveform, and the first recorded sample in the waveform has index equal to 1. The arrival of the second reflection, t₂=2t₁, determines the maximal extent of the time window for the processed part of the waveform. Using the above expression, the index I_{E}, corresponding to arrival t₂, denoting the maximum allowable sample index of the processed waveform, may be determined as follows:

$${I}_{E} = 1 + ⌊ \frac{{t}_{2} - {t}_{0}}{Δ t} ⌋ = ⌊ \frac{{t}_{0}}{Δ t} + 2 {I}_{A} ⌋ - 1 \qquad ( 13 )$$

with the corresponding boundaries to ensure correctness:

$${I}_{E} = min \{ N , {I}_{E} \} , {I}_{N} = min \{ {I}_{N} , {I}_{E} \} \qquad ( 14 )$$

In some embodiments, one or more samples may be subtracted from I_{E} to accommodate the additional uncertainty of determining t₁ from I_{A} and to eliminate any pollution from the second reflection signal.

As shown in FIG. 3, the processing window may then be defined (block 316). The definite beginning of the processing windows is indicated by index [I_{A}]. The processing window may then be further defined by clarifying the end of the processing window located at min {I_{C},I_{N}}.

The criteria used to select the optimal processing window may include the proximity of the location of the minimum of the group delay, τ_{g}=−Im(Z), and the location of the deflection point of the signed group duration time, Tᵣ=Re(Z), where Z(ω) is the complex group delay calculated for a given waveform and a particular processing window that begins at I_{A} and ends at another index j (discussed further infra). Metric s may be determined according to the following:

$${s}_{j} = \vert {f}_{m} - {f}_{d} \vert , {f}_{m} = arg {min}_{f} {τ}_{g} ( f ) , {T}_{r}^{′′} ( {f}_{d} ) = 0 \qquad ( 15 )$$

where τ_{g} and Tᵣ are calculated for the truncated waveform w_{└IA┘:j}, and the considered frequencies are limited to some predetermined neighborhood of the resonant frequency. The optimal processing window is expected to match the CGD's two characteristic points, thereby minimizing metric s.

In some embodiments, to reduce the amount of computations to as few as possible, the range of the end-indices of the processing window may be limited as follows:
1. If the previous analysis of a waveform (described supra) results in I_{C}<I_{N} (which is a desired result for no-noisy data), then j includes the following range:

$$j = {I}_{c} - M : {I}_{c} + M \qquad ( 16 )$$

In this instance, minimization may be performed around the desired index IC denoting the end of the window containing a nominal number of resonance cycles.
2. Otherwise, if the end-noise is present before the required number of resonance cycles in the waveform, j includes the following range:

$$j = {I}_{N} - M : {I}_{C} \qquad ( 17 )$$

In this instance, the value of constant M controls the number of processing windows for which the minimization of metric s is performed (for example, M=10).

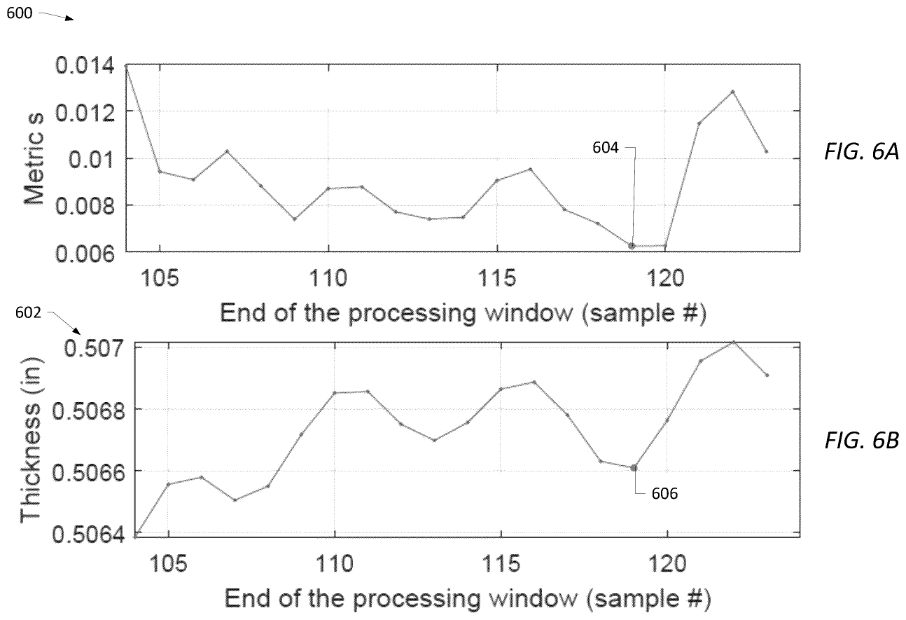

FIGS. 6A and 6B depict an example sweep through a range of processing windows for the waveform depicted in FIG. 4 and in accordance with an embodiment of the present disclosure. FIG. 6A includes a plot 600 of metric s vs sample number (#), and FIG. 6B depicts a plot 602 of the resulting casing thickness vs sample number (#), in which I_{C}<I_{N} and I_{C}=113. In FIGS. 6A and 6B, different processing windows are represented by their end-index with all processing windows begging at the same index └I_{A}┘. As shown in plots 600 and 602, different processing windows produce different casing thicknesses. Points 604 and 606 indicate values corresponding to the minimum of metric s. The processing window corresponding to the minimum 604 of metric s may be selected to produce a casing thickness 606 reflecting the most robust thickness estimation. In this example, a slightly larger processing window (ending at sample 119) may be selected instead of the requested window (I_{C}=113).

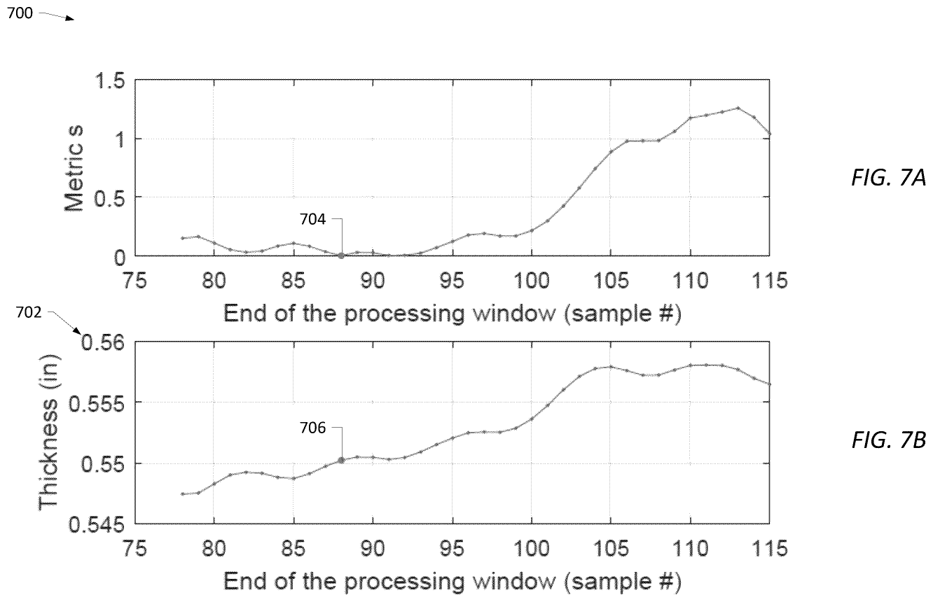

FIGS. 7A and 7B depicts another example sweep through a range of processing windows for the waveform depicted in FIG. 5 in accordance with an embodiment of the present disclosure. FIG. 7A includes a plot 700 of metric s vs sample number (#), and FIG. 7B depicts a plot 702 of the resulting casing thickness vs sample number (#), in which I_{C}<I_{N}, I_{N}=87, and I_{C}=115. Points 704 and 706 indicate values corresponding to the minimum of metric s and the corresponding casing thickness. In this example, the selected processing windows ends at sample 88, which is very close to the index I_{N} of 87 that denotes the beginning of the end noise. Large values of metric s toward larger window sizes indicate that the strong end-noise in the trailing part of the waveform introduces large perturbations in the complex group delay, thereby polluting the thickness estimation. Consequently, as shown in these figures, limiting the size of the processing windows for noisy waveforms may be beneficial in properly estimating the measured thickness.

Next, as shown in FIG. 3, the CGD (real and imaginary components) may be determined within the determined processing window (block 304). As discussed herein, the mathematical features of the real and imaginary components of the CGD, the deflection point and the local extremum respectively, indicate the resonance frequency in the processed signal and enable a resulting determination of casing thickness using Equation 2. The definition and properties of the CGD are discussed below.

As will be appreciated, a measured reflected waveform may be the convolution of the source impulse (the signal generated by the transducer), s(t), and the impulse response of the mechanical system, g(t), which incorporates all physical phenomena driving reflection of the source signal. Thus, in the time and frequency domains, the reflected waveform, y(t), and its spectrum, Y(ω), may be expressed as follows:

$$y ( t ) = s ( t ) * g ( t ) ↔ Y ( ω ) = S ( ω ) \cdot G ( ω ) = A ( ω ) {e}^{i ϕ ( ω )} \qquad ( 18 )$$

where t is time and ω is the angular frequency, A(ω) and ϕ(ω) are the real-valued amplitude and phase of the Fourier transform, respectively.

The complex group delay (CGD) of the signal Y(ω), may be calculated according to the following:

$$Z ( ω ) = \frac{d}{d ω} ln [ Y ( ω ) ] = \frac{d ln A ( ω )}{d ω} + i \frac{d ϕ ( ω )}{d ω} = {T}_{r} ( ω ) - i {τ}_{g} ( ω ) \qquad ( 19 )$$

where Tᵣ is the signed group duration time or the relaxation time (that is, the interval within which the signal energy is concentrated at a particular time), and τ_{g}(ω) is the classical group delay (GD).

The CGD may be determined using the definition of CGD set forth as follows:

$$Z ( ω ) = \frac{d}{d ω} ln [ y ( ω ) ] = \frac{{Y}^{′} ( ω )}{Y ( ω )} \qquad ( 20 )$$

where (·)' denotes taking the derivative with respect to ω and the well-known property of Fourier transform shown below:

$${Y}^{′} ( ω ) = \frac{d ℱ y ( t )}{d ω} = - i ℱ [ t \cdot y ( t ) ] \qquad ( 21 )$$

The above equations may be used to derive the following:

$${T}_{r} ( ω ) = Im ( \frac{ℱ [ t \cdot y ]}{ℱ [ y ]} ) \qquad ( 22 )$$

$${τ}_{g} = Re ( \frac{ℱ [ t \cdot y ]}{ℱ ⌈ y ]} ) \qquad ( 23 )$$

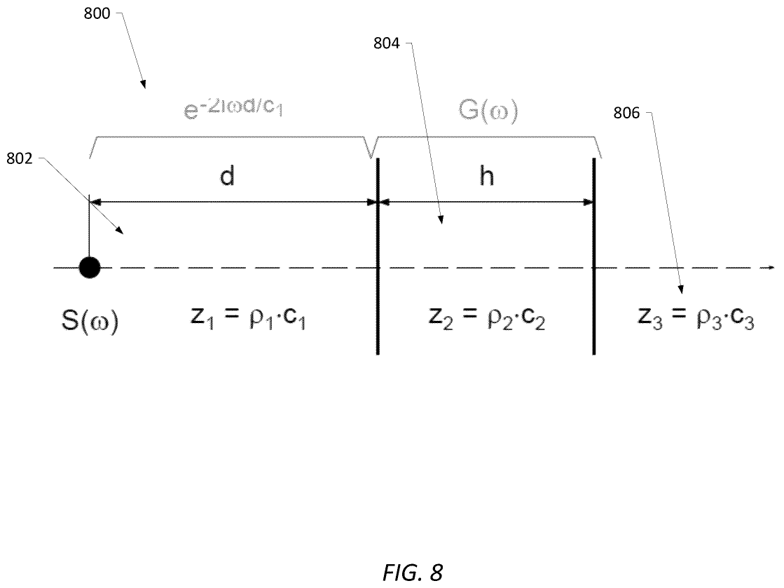

FIG. 8 depicts a 1D model 800 of the reflection from a loaded casing in accordance with an embodiment of the disclosure. As shown in FIG. 3, the first layer 802 contains an acoustic source, S(ω), represents borehole fluid of acoustic impedance z₁ (the product of density ρ₁ and acoustic velocity c₁) and is characterized by attenuation coefficient α(ω), which can be frequency-dependent. The source stand-off from the casing surface is denoted by d. The next layer 802 of thickness h represents a casing characterized by acoustic impedance z₂ (the product of density ρ₂ and compressional velocity c₂). Finally, the last layer 806 represents the material behind the casing with unknown impedance z₃ (the product of density ρ₃ and compressional velocity c₃).

Using the example of FIG. 8, the reflected signal in the frequency domain may be expressed according to the following:

$$Y ( ω ) = S ( ω ) \cdot G ( ω ) \cdot A ( ω ) \cdot {e}^{i ϕ ( ω )} , \qquad ( 24 )$$

$${ϕ}_{1} ( ω ) = k ( ω ) d = [ \frac{ω}{{c}_{1}} - i α ( ω ) ] d = ω {t}_{1} - i α ( ω ) d$$

where t₁=d/c₁ represents the one-way wave travel in a borehole fluid that allows for the separating of the impulse response G(ω) of the casing embedded in loads independent of the transducer location and the signature of the source pulse S(ω).

Calculating the CGD for the signal Y(ω) results in the following:

$$Z ( ω ) = \frac{d}{d ω} ln [ Y ( ω ) ] = \frac{{S}^{′} ( ω )}{S ( ω )} + \frac{{G}^{′} ( ω )}{G ( ω )} + \frac{{( {e}^{- 2 i {ϕ}_{1} ( ω )} )}^{′}}{{e}^{- 2 i {ϕ}_{1} ( ω )}} = {Z}_{S} ( ω ) + {Z}_{G} ( ω ) - 2 [ {α}^{′} ( ω ) d + i {t}_{1} ] \qquad ( 25 )$$

As shown above, the CGD of the convolved signal is an algebraic sum of the CGDs of each component of the convolution. Furthermore, the mud layer properties affect the complex group delay of the entire signal in two ways:
1) The imaginary part of the CGD (the classical group delay) is shifted by the amount corresponding to the two-way travel time, 211, in a mud layer (between the transducer and casing wall). Thus, knowing the arrival time of the reflected pulse with respect to the time corresponding to the first sample in a waveform, one can normalize group delay by subtracting this delay time; and
2) In the presence of the attenuation in a mud, the trend proportional to the derivative of the attenuation coefficient with respect to the frequency is added to the real part of the CGD. For a wide selection of muds, the attenuation coefficient can be approximated by monomial [symbol] , where α₀ is constant and 0 [symbol] n [symbol] 2. This implies that the trend affecting Tᵣ( [symbol] ) is close to linear and, usually, slowly varying.

The additivity property of the CGD implies that the study of the dependence of the CGD on the geometry and the material properties of the casing and the load can be restricted to the study of the effect of G(ω) solely, provided that the S(ω) and properties of mud layer are known. The reflection coefficients R1 and R2 and auxiliary quantity Q(ω) may be defined as follows:

$$R 1 = \frac{{z}_{2} - {z}_{1}}{{z}_{2} + {z}_{1}} , 0 < {R}_{1} < 1 as {z}_{1} ≪ {z}_{2} \qquad ( 26 )$$

$$R 2 = \frac{{z}_{3} - {z}_{2}}{{z}_{3} + 2} , - 1 < {R}_{2} < 0 as {z}_{3} ≪ {z}_{2} \qquad ( 27 )$$

$$Q ( ω ) = {e}^{- 2 i {ϕ}_{1} ( ω )} = {e}^{\frac{- i ω}{{f}_{r}}} = {e}^{\frac{- 2 π i f}{{f}_{r}}} \qquad ( 28 )$$

Where the resonant frequency is given by Equation 2, the response function may be determined directly as:

$$G ( ω ) = {R}_{1} + ( 1 - {R}_{1}^{2} ) {R}_{2} Q ( ω ) {{\sum }_{k = 0}^{∞} [ - {R}_{1} {R}_{2} Q ( ω ) ]}^{k} = \frac{{R}_{1} + {R}_{2} Q ( ω )}{1 + {R}_{1} {R}_{2} Q ( ω )} \qquad ( 29 )$$

Using this expression, the CGD of the reflection response, G(ω), can be calculated as follows:

$${Z}_{G} ( ω ) = \frac{{G}^{″} ( ω )}{G ( ω )} = - \frac{i}{{f}_{r}} \frac{( 1 - {R}_{1}^{2} ) {R}_{2} Q ( ω )}{[ 1 + {R}_{1} {R}_{2} Q ( ω ) ] [ {R}_{1} + {R}_{2} Q ( ω ) ]} \qquad ( 30 )$$

As shown above, the CGD scales inversely proportional to the resonance frequency fᵣ, which also implies that the CGD scales proportionally to the casing thickness; that is, the product Z_{G}(ω)·fᵣ is invariant.

The properties of CGD for the non-windowed signal are straightforward and provide insight into the CGD's general behavior at the resonant frequency. At the resonance frequency, ωᵣ=2πfᵣ, Q(ωᵣ)=1, Equation 30 simplifies to the following:

$${Z}_{G} ( {ω}_{r} ) = - \frac{i}{{f}_{r}} \frac{( 1 - {R}_{1}^{2} ) {R}_{2}}{( 1 + {R}_{1} {R}_{2} ) ( {R}_{1} + {R}_{2} )} \qquad ( 31 )$$

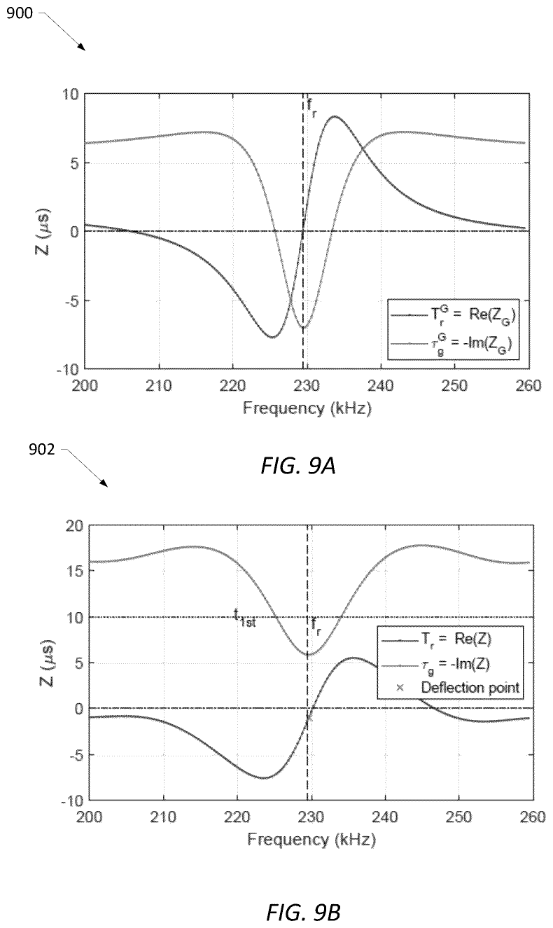

FIGS. 9A and 9B show a typical behavior (for z₁<z₃) of ZG(ω) around the resonant frequency in accordance with an embodiment of the disclosure. FIGS. 9A and 9B depicts the CGD for the 1st reflection part of the waveform for which one-way mud travel time t1=5 u/s and fluid attenuation α(ω)=5·10⁻⁶ ω². FIG. 9 depicts a plot 900 that includes CGD vs frequency calculated for impulse response G(ω), and FIG. 9B depicts a plot 902 of CGD vs frequency that also includes the mud layer.

As shown in FIGS. 9A and 9B, the real part of the CGD, Tᵣ^{G}(ω), vanishes at the resonant frequency, and is locally an antisymmetric function of the frequency, having the deflection point (the point with zero curvature) exactly at the resonance frequency. Moreover, regardless of the value of the load impedance z₃((which can be larger or smaller than mud impedance z1), the derivative of Tᵣ^{G}(ω) with respect to the frequency at fᵣ is always positive. Further, the imaginary part of the CGD attains an extremum at the resonant frequency and may be determined according to the following:

$${τ}_{g}^{G} ( {ω}_{r} ) = - \frac{i}{{f}_{r}} \frac{( 1 - {R}_{1}^{2} ) {R}_{2}}{( 1 + {R}_{1} {R}_{2} ) ( {R}_{1} + {R}_{2} )} \qquad ( 32 )$$

The CGD for the system involving the mud layer is modified according to Equation 25. Plot 902 of FIG. 9B shows a typical behavior (for z₁<2₃) of Z(ω) around the resonant frequency. As seen in this figure, the imaginary part of the CGD is shifted vertically by 10 μs, which is equal to the two-way wave travel time in the mud minus the time corresponding to index i₀, where the original waveform has been truncated. However, the frequency location of the minimum of the group delay remains nearly intact, enabling casing thickness assessment. Additionally, the real part of the CGD is affected in the more complex way due to the presence of attenuation in a mud. A weakly nonlinear trend is added to T^{G}(ω). As a result, the zero-crossing abscissa does not correspond anymore to the resonant frequency. However, the calculated numerically the deflection point of the curve T(ω) (marked with red ‘x’ in FIG. 3b) identifies the resonant frequency much better. The above properties facilitate robust determination of the resonant frequency and, consequently, casing thickness.

As mentioned supra, the derivations described herein assume that the CGD is calculated for the entire signal y(t). However, as discussed in the disclosure, eliminating the undesirable transducer interference (the 2nd and consecutive reflections) requires restricting the signal to the first reflection and its reverberations only. Truncating the waveform in the time domain corresponds mathematically to multiplying the original signal, y(t), by a window function, w(t). In the frequency domain, this results in a convolution of the spectrum of the original signal, Y(ω), with the spectrum of the window function, W(ω). In result, the CGD of such a partial waveform can be expressed as the following more complex expression:

$${Z}_{ω} ( ω ) = \frac{d}{d ω} ln [ Y ( ω ) * W ( ω ) ] = \frac{{( Y * W )}^{′}}{Y * W} = \frac{Y * {W}^{′}}{Y * W} = \frac{{Y}^{′} * W}{Y * W} \qquad ( 33 )$$

The technique described in the disclosure eliminates the calculation of the convolutions of the spectra required by Equation 33 and thus reduces the complexity of the determination, resulting in reduced use of computing resources (for example, processing resources).

After determining the CGD, the resonant frequency may be determined (block 308) using, for example, Equation 30. As discussed supra, the resonant frequency may be identified using the real and imaginary components of the CGD—the minimum of the imaginary component and the deflection point of the real component may, individually or in combination, be used to identify the resonant frequency. After determining the resonant frequency, the casing thickness may be identified according to Equation 2. As will be appreciated, the determination may include the compressional velocity in steel c₂ and the correction factor β related to the Poisson ratio of the casing material (obtainable based on the known casing material). The casing thickness may be used to evaluate the condition of the casing and determine whether tubing may be run into the wellbore. For example, a determination of casing thickness may be followed by installation of production tubing in the wellbore if the casing thickness exceeds a threshold value.

Embodiments of the disclosure, such as aspects of the process 300, may be implemented in a processing system or processing device (for example, controller 216). Such systems or devices may include a central processing unit (CPU), a computer-readable media (for example, random access memory (RAM), read-only memory (ROM), solid-state memory (SSD) drives, hard drives), input and output control units, and a network interface (for example, wired or wireless network interface). Such systems and devices may, in some embodiments, include, a display, a user interface, input device, and other components. Such systems and devices may include executable code stored in the computer-readable media. The executable code according to the present disclosure is in the form of computer operable instructions causing the data processor to receive input data and provide outputs based on processing the input data. The computer-operable instructions of the executable code may execute processes and determine a complex group delay, a resonant frequency, and a casing thickness according to the techniques described in the disclosure.

It is to be further understood that the scope of the present disclosure is not limited to the exact details of construction, operation, exact materials, or embodiments shown and described, as modifications and equivalents will be apparent to one skilled in the art. In the drawings and specification, there have been disclosed illustrative embodiments and, although specific terms are employed, they are used in a generic and descriptive sense only and not for the purpose of limitation.

Ranges may be expressed in the disclosure as from about one particular value, to about another particular value, or both. When such a range is expressed, it is to be understood that another embodiment is from the one particular value, to the other particular value, or both, along with all combinations within said range.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments described in the disclosure. It is to be understood that the forms shown and described in the disclosure are to be taken as examples of embodiments. Elements and materials may be substituted for those illustrated and described in the disclosure, parts and processes may be reversed or omitted, and certain features may be utilized independently, all as would be apparent to one skilled in the art after having the benefit of this description. Changes may be made in the elements described in the disclosure without departing from the spirit and scope of the disclosure as described in the following claims. Headings used in the disclosure are for organizational purposes only and are not meant to be used to limit the scope of the description.

What is claimed is:

1. A method of determining a thickness of a casing installed in a wellbore, the method comprising:
obtaining a signal measured by a downhole tool inserted in wellbore of a well, the acoustic signal generated by an acoustic pulse emitted by the downhole tool such that the acoustic pulse contacts the casing;
determining a processing window in the signal by windowing the signal to a first reflection and reverberations of the first reflection;
determining a complex group delay (CGD) in the processing window, the complex group delay having a real component and an imaginary component;
identifying a resonant frequency from the complex group delay; and
determining the casing thickness using the resonant frequency.

2. The method of claim 1, wherein the identifying a resonant frequency from the complex group delay comprises identifying the resonant frequency from a minimum of the imaginary component of the complex group delay (CGD).

3. The method of claim 1, wherein the identifying a resonant frequency from the complex group delay comprises identifying the resonant frequency from a deflection point of the real component of the complex group delay (CGD).

4. The method of claim 1, wherein determining the casing thickness using the resonant frequency comprises determining the casing thickness h using the following:
$${f}_{r} = \frac{β {c}_{2}}{2 h}$$
where fᵣ is the resonant frequency, β is a correction factor related to the Poisson ratio of the casing material, c₂ is the compressional velocity in steel, and h is the casing thickness.

5. The method of claim 1, wherein determining the processing window in the signal by windowing the signal to a first reflection and reverberations of the first reflection comprises:
determining the first reflection and associated noise;
determining an arrival time and second reflection; and
defining the processing window based on a proximity of a minimum of the imaginary component of the complex group delay (CGD) and a deflection point of the real component of the complex group delay (CGD).

6. The method of claim 1, wherein the downhole tool comprises an ultrasonic transducer oriented perpendicularly to the casing.

7. The method of claim 1, wherein the complex group delay (CGD) Z_{G}(ω) is determined according to the following:
$${Z}_{G} ( ω ) = - \frac{i}{{f}_{r}} \frac{( 1 - {R}_{1}^{2} ) {R}_{2} Q ( ω )}{[ 1 + {R}_{1} {R}_{2} Q ( ω ) ] [ {R}_{1} + {R}_{2} Q ( ω ) ]}$$
where fᵣ is the resonant frequency, R1 is a first reflection coefficient, R2 is a second reflection coefficient, and Q(ω) is an auxiliary quantity.

8. A non-transitory computer-readable storage medium having executable code stored thereon for determining a thickness of a casing installed in a wellbore, the executable code comprising a set of instructions that causes a processor to perform operations comprising:
obtaining a signal measured by a downhole tool inserted in wellbore of a well, the acoustic signal generated by an acoustic pulse emitted by the downhole tool such that the acoustic pulse contacts the casing;
determining a processing window in the signal by windowing the signal to a first reflection and reverberations of the first reflection;
determining a complex group delay (CGD) in the processing window, the complex group delay having a real component and an imaginary component;
identifying a resonant frequency from the complex group delay; and
determining the casing thickness using the resonant frequency.

9. The non-transitory computer-readable storage medium of claim 8, wherein the identifying a resonant frequency from the complex group delay comprises identifying the resonant frequency from a minimum of the imaginary component of the complex group delay (CGD).

10. The non-transitory computer-readable storage medium of claim 8, wherein the identifying a resonant frequency from the complex group delay comprises identifying the resonant frequency from a deflection point of the real component of the complex group delay (CGD).

11. The non-transitory computer-readable storage medium of claim 8, wherein determining the casing thickness using the resonant frequency comprises determining the casing thickness h using the following:
$${f}_{r} = \frac{β {c}_{2}}{2 h}$$
where fᵣ is the resonant frequency, β is a correction factor related to the Poisson ratio of the casing material, c₂ is the compressional velocity in steel, and h is the casing thickness.

12. The non-transitory computer-readable storage medium of claim 8, wherein determining the processing window in the signal by windowing the signal to a first reflection and reverberations of the first reflection comprises:
determining the first reflection and associated noise;
determining an arrival time and second reflections; and
defining the processing window based on a proximity of a minimum of the imaginary component of the complex group delay (CGD) and a deflection point of the real component of the complex group delay (CGD).

13. The non-transitory computer-readable storage medium of claim 8, wherein the downhole tool comprises an ultrasonic transducer oriented perpendicularly to the casing.

14. The non-transitory computer-readable storage medium of claim 8, wherein the complex group delay (CGD) Z_{G}(ω) is determined according to the following:
$${Z}_{G} ( ω ) = - \frac{i}{{f}_{r}} \frac{( 1 - {R}_{1}^{2} ) {R}_{2} Q ( ω )}{[ 1 + {R}_{1} {R}_{2} Q ( ω ) ] [ {R}_{1} + {R}_{2} Q ( ω ) ]}$$
where fᵣ is the resonant frequency, R1 is a first reflection coefficient, R2 is a second reflection coefficient, and Q(ω) is an auxiliary quantity.

15. A system for determining a thickness of a casing installed in a wellbore, the system comprising:
a downhole tool comprising an ultrasonic transducer oriented perpendicular to the casing;
a controller communicatively coupled to the downhole tool, the controller comprising a non-transitory computer-readable memory having executable code stored thereon, the executable code comprising a set of instructions that causes the controller to perform operations comprising:
obtaining a signal measured the downhole tool, the acoustic signal generated by an acoustic pulse emitted by the downhole tool such that the acoustic pulse contacts the casing;
determining a processing window in the signal by windowing the signal to a first reflection and reverberations of the first reflection;
determining a complex group delay (CGD) in the processing window, the complex group delay having a real component and an imaginary component;
identifying a resonant frequency from the complex group delay; and
determining the casing thickness using the resonant frequency.

16. The system of claim 15, wherein the identifying a resonant frequency from the complex group delay comprises identifying the resonant frequency from a minimum of the imaginary component of the complex group delay (CGD).

17. The system of claim 15, wherein the identifying a resonant frequency from the complex group delay comprises identifying the resonant frequency from a deflection point of the real component of the complex group delay (CGD).

18. The system of claim 15, wherein determining the casing thickness using the resonant frequency comprises determining the casing thickness h using the following:
$${f}_{r} = \frac{β {c}_{2}}{2 h}$$
where fᵣ is the resonant frequency, β is a correction factor related to the Poisson ratio of the casing material, c₂ is the compressional velocity in steel, and h is the casing thickness.

19. The system of claim 15, wherein determining the processing window in the signal by windowing the signal to a first reflection and reverberations of the first reflection comprises:
determining the first reflection and associated noise;
determining an arrival time and second reflection; and
defining the processing window based on a proximity of a minimum of the imaginary component of the complex group delay (CGD) and a deflection point of the real component of the complex group delay (CGD).

20. The system of claim 15, wherein the complex group delay (CGD) ZG(ω) is determined according to the following:
$${Z}_{G} ( ω ) = - \frac{i}{{f}_{r}} \frac{( 1 - {R}_{1}^{2} ) {R}_{2} Q ( ω )}{[ 1 + {R}_{1} {R}_{2} Q ( ω ) ] [ {R}_{1} + {R}_{2} Q ( ω ) ]}$$
where fᵣ is the resonant frequency, R1 is a first reflection coefficient, R2 is a second reflection coefficient, and Q(ω) is an auxiliary quantity.
